(19) United States
(12) Patent Application Publication
(10) Pub. No.: US 2013/0208114 A1
(43) Pub. Date: Aug. 15, 2013

(54) Digital Bedbug Indicator: A bedbug insect peripheral electronic detection unit device

(71) Applicant: JODY ARTHUR BALSAM, Burbank, CA (US)

(72) Inventor: JODY ARTHUR BALSAM, Burbank, CA (US)

(73) Assignee: Jody Arthur Balsam, Burbank, CA (US)

(21) Appl. No.: 13/764,793

(22) Filed: Feb. 12, 2013

Related U.S. Application Data
(60) Provisional application No. 61/756,691, filed on Jan. 25, 2013.

(51) Int. Cl. H04N 7/18

(52) U.S. Cl. CPC H04N 7/188
USPC 348/143

(57) ABSTRACT

The Digital bedbug indicator is a extended defined first alert peripheral electronic device for Pest Management Professionals, providing increased early warning notification before a newly occurred infestation or re-infestation of bed bugs occur.

Digital bedbug indicator is a bed bug insect peripheral electronic detection unit device. It elicits a immediate electronic notification in response of the presence of bed bugs. It requires conjunctions with other common digital motion detection software devices. Immediately transferring electronic messages notification to the pest management professional with either: email alert, TV, lights, but not limited to. A extended defined first alert peripheral electronic device for pest management professionals, providing increased early warning notification before a newly occurred infestation or re-infestation of bed bugs is escalating.

### FIELD OF THE INVENTION

The field invention will be saving valuable time and costly constant re-inspections. The field of bed bug preventive monitoring and concurrent bed bug inspections, that are performed either by trained animals or exterminators. The invention is relevant in the field of bedbug inspections. The device is specifically designed to be an ongoing early detection, of bedbugs by pest management professionals. A insect monitoring electronic peripheral device that is a part of a system of other electronic common devices to produce the immediate notification directly to the PMP of bed bug awareness. The biting blood sucking insects that are the preferred target are bed bugs (Cimex lectularus, and Cimex hemipterus).

### BACKGROUND TO THE INVENTION

Bed bugs (Cimex lectularius and Cimex hemipterus) are small tick like looking insects that survive on the blood of humans and other warm-blooded hosts. Bed bugs most likely hide, but not limited to, concealment in daylight hours in dark enclosed sites and have a preference for cracks and crevices in fabric, wood, paper, gritty sandpaper like surface's.

Bed bugs are attracted to heat, scented bed bug excrement and carbon dioxide given off by warm-blooded mammals, birds and themselves. That makes sleeping areas, clutter, furniture, especially mattresses, box springs, nightstands and headboards, all are an ideal environments for bedbugs to have concealment. Bed bugs are known for being mainly active at night, making their sightings difficult.

The inspiration of the invention is for professional integrated pest management controllers. Lessening or avoiding inspection time for exterminators who spend countless hours inspecting and returning to bed bug traps of many kinds.

When the bites inflicted by bed bugs may create a dermatological reaction in some humans, this usually cannot be felt until some time, if any or on some people, days after the bug bites have occurred. The first indication of a bite usually comes with not knowing exactly what location or when the insect did there biting. Such as at the hotel, over a friends house, or the couch where people traffic to. In many occurrences there is no reaction for many months or until sightings of the bed bugs are seen or the excrement and blood stains are found on the surface of where they are feeding frequently.

Waiting for the bed bugs to bite to confirm an intrusion, has many disadvantages, for example, the bites are very similar to that of other insect bites and difficult to identify. Detecting the bedbugs before they bite would be better. What the invention induced purpose is to create a shorter waiting curve of bedbug appearances. Where the click of a computer mouse can observe multipliable locations all at once or the pest management professional(s) controller, being notified of a bedbug(s) that has/have appeared in the invention. And that the units are all working properly.

Other methods of enticing bed bugs, is to use glue traps, often in conjunction with warm heat and possibly carbon dioxide source to attract the bedbugs. These such devices are needed to be reinserted and re-inspected with an ongoing program of inspections, which may be that a trap(s) is in a placement that may be forgotten. The invention is placed once, and is awaiting to notify the pest management professional electronically that a bed bug has entered the location.

Using double-sided masking tape is effective. But requires travel and time to inspect by professional exterminator companies. Costing the client high costs.

The pandemic worldwide increase in bedbugs, highlights the need for a solution to the problems they cause and this brief review of known attempts to detect and eliminate them (all of which are based around active capture) shows that there is no clear starting point, and indeed no satisfactory universal solution from which the problem may be tackled. Unless increased early detection is plausible/possible with the bed bug insect peripheral electronic detection notification unit device. Producing even email alerts with other connecting common electronic devices. Saving valuable time and costly constant re-inspection time before an prolific infestation is problematic at the location of placements of invention.

### BRIEF SUMMARY OF THE INVENTION

The invention seeks to lure and capture the bedbugs. The present invention is based on there known attraction to a refuge enclosure with grasping, gripping surface's providing bonus cracks and crevices. Also offering, attractive things to there sensory organs, commonly known, natural chemical attractants, such as bed bug excrement lure or also known as bed bug fecal pheromones, including warm heat, and Co2. These include the observation that: a) Bedbugs leave a scent of excrement defecate in their place of refuge to that compasses there return to; b) Bed bugs favor a gritty material tight space refuge, comprising of crevices, in dark, but not limited to, particularly attracted to a sensory tight space. Bed bugs, when captured by, said completed system operating invention unit, produce information to set off an alarm, warning pest management professionals such as exterminators, hotel managers, apartment owners and but not limited to.

Once notified of the bedbug intruder alert: the knowledge gained from observation, the pest management professional has proof of intruder of bedbug immediately. The invention will notify from its location to the PMP by electronic mail, IP, visual monitors, but not limited to, that has the other electronic peripheral common devices and or internet connections.

According to the first presents of bed bugs detected by the invention it has provided absolute bed bug proof of detection.

The invention elicits a taxis response to a pest management professional; to schedule a treatment, for a eradication of bed bugs immediately notifying another PMP designed to do so. Such as a professional exterminator.

Before eradication procedure begins, from the pest management professional exterminator, that perform the extermination of bedbugs, the invention placements are easily disconnected and removed for there protection, until after the structure has finished being treated for bedbugs.

After eradication procedures has taken place for the bed bugs in a room. Then the original invention placements are re-set to there connective intelligence according to the instruction manual. This creates quality assurance of continual monitoring electronically, that any new re-invasions that may occur in the future. The invention will notify pest management professional(s) immediately.

The invention device comprising of a refuge enclosure, has a non-trapping/trapping indicator in the interior. It is the detection surface. It's enhanced purpose is to provide a constant visual electronic scope inspection for the security motion detection cameras and devices in conjunction for the early bedbug detection protection programs.

According to the aspect of the present invention, it is there to provide a early warning passive method of detecting the presence of bed bugs with or without their capture comprising of visual LCD/TV screen monitoring with digital video recorder with alert programming to the bedbugs movement within the invention. This device elicits a taxis response, from motion detection to DVR or Computers with the common software for this operating systems management. That in turns notify's the pest management professional(s) by e-mail, bells, lights alarms and other but not limited to other warning device's.

When invention is placed in or is attached to under a bed frame, a bed headboard or a mattress edge, the bed bugs, but not limited to, will be enticed to crawl into the invention because of scented excrement lure, warm heat, crevices and location placement of the unit. When crawling over the non-trapping/trapping indicator surface this will trigger and may include to leave an indication of their presence. Identified such as on a, but not limited to visual TV, LCD screen, recorded VCR, DVR or computer generated operating in communication with the invention.

The self-inspecting device is self supporting. But if at regular intervals, the pest management professional will want to inspect the screening visual monitors for the presence of bed bugs at any time, or to confirm the invention is operating properly.

The invention that is connected to known bed bug hiding areas, may be held in place by a connecting clip, screws, glue or by the use of Velcro, two part series, one side fuzzy the other part with grab, both having adhesive on the other side is particular desirable as it means the device can be easily removed for maintenance every six months or if a eradication is to take place.

The field invention peripheral device will be saving valuable time and costly constant re-inspections.

### BRIEF DESCRIPTION OF THE DRAWINGS

The drawings are part of the specification and include detailed visual descriptions of the invention that maybe embodied in various forms and size's. Some aspects of the invention drawings may be shown exaggerated for a better perspective understanding of the performing invention.

FIG. 1 is the front perspective view of the invention.

FIG. 2 is the top perspective view of the invention.

FIG. 3 is the bottom perspective view of the invention.

FIG. 4 is the right side perspective view of the invention.

FIG. 5 is the transparent perspective front view of invention demonstrating only top of invention exploded.

FIG. 6 is the entire exploded transparent front side view of the invention.

FIG. 7 is a perspective 2D view of a room in a structure of common anonymous placements of where the invention might be placed.

FIG. 8 is the 2D perspective view of a flow chart of the other common reactive electronic, non electronic, operating system devices when invention is in conjunction with, to produce a immediate first alert digital notification to PMP.

### DETAILED DESCRIPTION OF THE INVENTION

An embodiment of the invention will now be described, by way of example only, with compass references to the accompanying 8 figure drawings, in which is explained definitively:

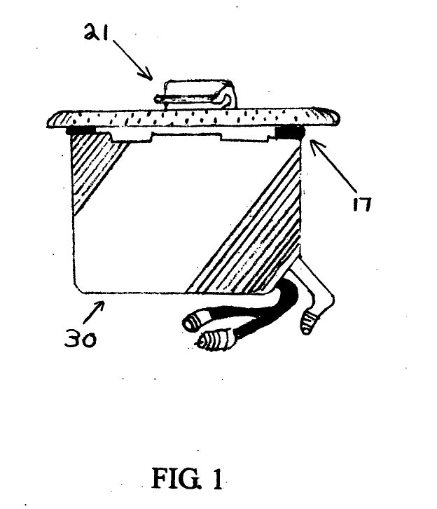

FIG. 1 is the front perspective view of the invention. A plastic rectangular looking box, indicating the outer smooth encasement (1) by slanted upgrading from left to right multiple (30) lines indicating a smooth surface. A beveled (3) gritty (16) sandpaper type plastic cover cap on top, just slightly over lapping the edge of the embodiment (1). There are cracks (2) where the Bedbugs can enter, where the two meet. On the top of cap (21) of box is a attachment clip with a front view. Along the bottom right side corner of embodiment, with one cable (31) protruding, that splits in two, a power line connection (32) and a video feed line connection (18) and next to protruding object (6) is a Co2 inlet plastic tube connector.

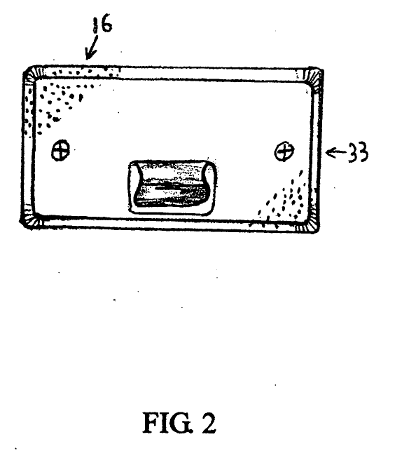

FIG. 2 is the top perspective view of the invention. A plastic cap that is treated with a gritty (16) sandpaper type surface paint spray that is dried on the interior and exterior of the cap. Showing dots in corners from upper left to lower right indicating gritty surface cap of FIG. 2 box attachment. This top cap is connected with two screws (33) that is attached to the plastic encasement box (1) smooth outer encasement. Including on top of cap of box is a snap on attachment clip (21) with a top view.

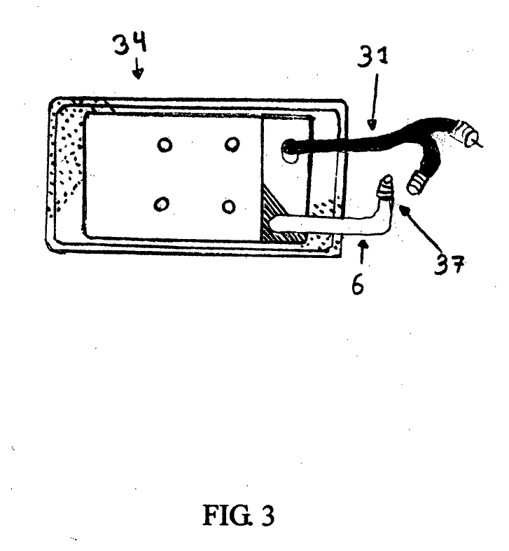

FIG. 3 is the bottom perspective view of the invention. There are four holes (34) that are used to place the bolts (35) thru to hold the camera (4) and led's (7) in place. The upside bottom surface (1) view showing indicating smooth surface. (except for underneath extended gritty cap) The bedbugs can enter the interior of thru crevice (2) of invention shown on the left side of drawing. On the right side of drawing with one cable (31) protruding that splits in two, a power line connection (32) and a video feed line (18) connection.

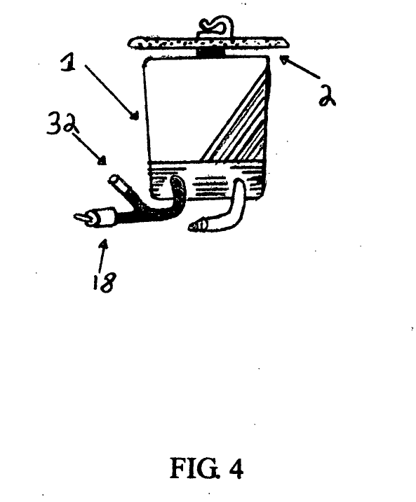

FIG. 4 is the right side perspective view of the invention. Showing slanted upgrading from left to right multiple lines indicating smooth surface (30) except for gritty cap (16) at top of box. This is where the bedbugs can (2) enter. On the top of cap of box is a attachment clip with a right side view (21) Along the bottom corner of embodiment, with one cable (31) protruding that splits in two, a power line connection (32) and a video feed line connection (18) and next protruding object (6) is a Co2 inlet plastic tube connector.

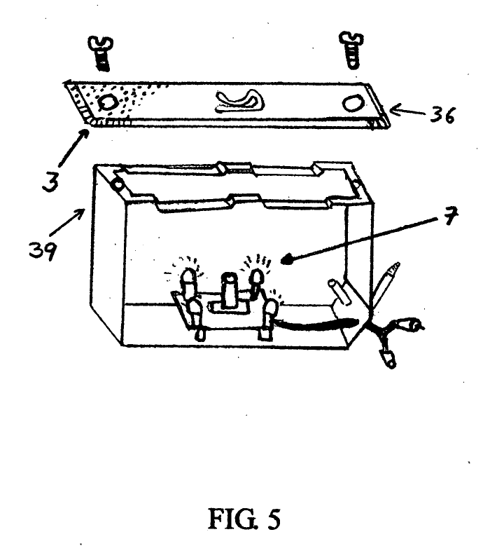

FIG. 5 is the transparent view of invention demonstrating only top of invention exploded. Illustrates the invention unit in an almost functioning prospective with looking on the inside interior of the gritty top cap (16) not properly in it's place but exploded off (1) the top of invention. There is a optional bed frame clip (plastic or metal) (21) to hold invention to the bed frame but not limited to. May be Velcro attachments, glue, or two sided tape. The cap is beveled (3) of invention with surface being a gritty (16) surface both sides of cap of invention. There are two holes (36) for locking screw entrances. The two screw bolts (33) are placed thru holes shown (36) to hold tight and lock down the cap to the invention plastic encasement embodiment (1) where there is a space ring (17) between them. The space ring (17) is to provide for a slight air exhaust flow from the Co2 inlet (6) from within and lure smell from within interior of invention The space ring (17) also is a spacer for bed bugs to enter thru a crack or crevice (2) of where the cap hovers and meets over the smooth surface plastic encasement embodiment edges. As is FIG. 4, controlling the thickness of spacer ring (17) also controls the size of insects that can enter such as spiders, roaches and ticks, but not limited to. A outer smooth surface encasement embodiment (1) on all sides, that holds and protects all the interior electronics and parts that create the invention except for the protruding cable that splits (31) and the plastic Co2 inlet connector (6) tube line. A small tubing connector for Co2 inlet, with funnel edges (37) for easy connection and control of inletting Co2 gas inlet for interior and exterior of line. The purpose of which is to introduce Co2 to the interior of invention where it seeps out where the gritty cap covers the invention. This is because invention has a spacer and creates a escape crack and crevice between the cap and encasement when bolted down. As in FIG. 1 There is a plug connection from video NTSC, output connector, (18) sending decoded information to systems operating device such as computer (10), VCR (9) or DVR (9) with common software program to the needs of motion detection alert response. The camera, and light emitting diodes (7) are powered by 12 vdc connector (32) input, that must be connected to an from a exterior (38) 12 vdc source.

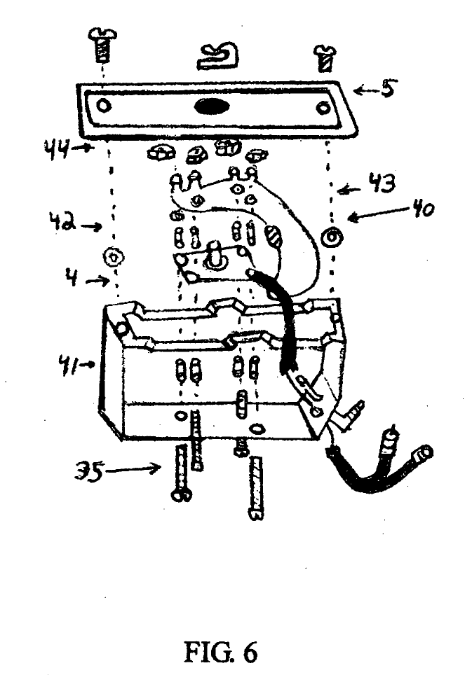

FIG. 6 is the entire exploded transparent front side view of the invention. Exploded view graphically schematically illustrates but not limited to these being the permanent proportional size of any measurements of the invention components. There is a cap beveled edge (3) of invention is 0.008 of an inch thick. 2.75 inch Wide×4.25 inch long. Beveled cap of invention with surface being a gritty surface (16) both outside and inside under of the cap of invention. There is a optional bed frame clip (21) (plastic or metal) to hold invention to the bed frame or other objects. 1″×1″×0.5″ but not limited to, is attached to top of outer perimeter on top of cap of invention. May be Velcro attachments, glue, tape and not excluding screw and brackets. There are two screw bolts (33) one on each side, to hold tight and lock down the cap FIG. 2,3,1 to invention encasement. 0.5.″ long screw bolt thru hole shown (39), in ledge of encasement. The space ring placements (17) between cap and embodiment of invention , to create crack and crevice for air exhaust flow of Co2 and lure smell emitting exiting from interior of invention. The space ring 0.25″wide cross circumference by 0.2 thick space ring. Also acting as spacer for bed bugs to enter thru a crack or crevice of where it hovers and meets over the invention plastic encasement embodiment edges. The smooth embodiment encasement (1) that holds and protects all the electronics and parts that create the invention 3.5″long×2.25″wide×3″High. The wall thickness (1) of the embodiment is 0.008″. But not limited to. A smooth encasement embodiment on all sides, that holds and protects all the electronics and parts that create the invention. There is a small Co2 tube connector (6) pipe 0.25″ wide with funnel edge (37): 0.5″ long extending from exterior corner. Interior inclosing funnel 1″ long ending with orifice hole 0.05′ wide but not limited to. The purpose of which is to introduce Co2 to the interior of invention where it seeps out where the gritty cap cover has a escape crack and crevice between the cap and invention encasement which is made possible from the spacer ring. A connection output ; outputting from video NTSC camera (4). This connector is 1″ long×0.25″ wide but limited to. A connection for video NTSC, output (18) sending decoded information to systems operating device such as computer (10), VCR or DVR (9), with common software program to the needs of motion detection creating first alert. The camera, and light emitting diodes are powered by 12 vdc connector input, (32) that must be connected to an from a exterior (38) 12 vdc source. There are 4 but not limited to, infrared light emitting diode (7), 5 mm at 30 degrees. The led's are in series with a power load resister (40) connection from 12 vdc. The resister (40) 10 k ohms, is so infrared diodes (7) don't bum out. It is connected to the positive connection of the 12 vdc voltage before excessive electrons reach the diodes. Its purpose is to slow down the speed in which the electrons in the circuit flow. There is a small video NTSC camera unit {12 VDC 125 ma} for invention 1″×1″×1″ wide. This unit is in direct connection with video feed (18) and 12 vdc power plug (32). The plastic separator tube inserts (41) 0.25″long×0.1″ wide tube. Are separators for air currents and grounding electrical circuits from static electrical connects and to stop direct static electrical connections that are not warranted. There placements are between the bottom camera (41) and encasement embodiment. Also including separators between the top of camera (42) and ring led holder (43). There are (35) small bolts, 0.75″ long×0.0085″ wide, 4 of them. These bolts are attaching all components that are camera and led related. Static grounding tubes (41), led ring holders (43) that are secured with the hex nuts (44) that screw to tighten down the components to give a secured transparent picture like that of FIG. 5. The (44) hex nuts 0.1″×0.1″ for bolting, locking down on top of led's ring holders (43) for connecting to (35) screw bolts. There is a glue board scent lure location (5); In the middle stuck underneath the cap. 1.50′ long scented glue×0.5″ wide. This is where the bedbugs maybe enticed, lured, and indicated into where they are detected by motion with the infrared camera on adjacent opposite wall from interior of invention, as in FIG. 5 connected external to motion detection software in a computerized operations systems. The trap device or glued insect lure gel strip constitutes a throwaway item intended for so-called one shot usage only to keep the visual clear on the digital video recorder or LCD screen monitor. Replacement should be every six months and dated for visual acquisitions when no occurrences have happened.

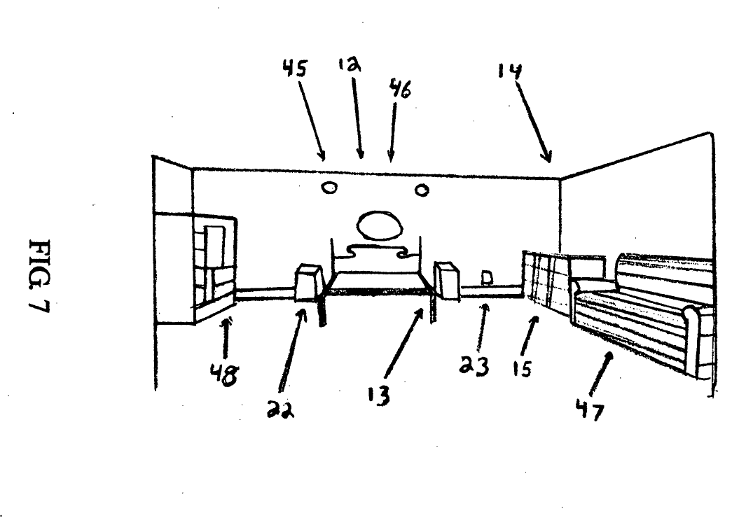

FIG. 7 is a perspective 2D view of a room in a structure of common anonymous placements of where the invention might be placed. This is a perspective view of 16 hidden placement locations. Primarily geared for hotel/motel industry but not limited too. Graphically illustrates 16 invention unit placements in hidden perspective view of targeting bedbug determination diagnostic technology. These perspective locations can be in any living room including bed rooms of any residential or commercial structure. First suggested location placements of invention in structural room: is disguised as two smoke alarms (45) or dome covers. invention is attach in wall protruding behind plaster board such as a wall socket would be for example. Invention is wired within conduit to exiting baseboard area where it meets with main cable to communicate to device such as a DVR. Stealth discreet and savvy locations. Second suggested location placements of invention in structural room: is behind mirror (46) or picture frame. Where invention is attach in plaster board such as a wall socket would be for example, invention is wired within conduit to exiting baseboard area where it meets with main cable to communicate to device such as a DVR. Stealth discreet and savvy location. Third suggested location placements of invention in structural room: is behind head boards, two units of the invention is attach in plaster board such as a wall socket would be for example. Invention is wired within conduit to exiting baseboard area where it meets with main cable to communicate to device such as a digital video recorder. Fourth suggested location placements of invention in structural room: is under dresser (15), closest to wall baseboard area where it meets with main cable to communicate to device such as a digital video recorder. Fifth suggested location placements of invention in structural room: is under couch (47) or in couch area where it then meets with main cable to communicate to device such as a digital video recorder. Sixth suggested location placements of invention in structural room: is where the two night stands are next to bed underneath, (22) closet to baseboards area where it meets with main cable to communicate to device such as a digital video recorder. Seventh suggested location placements of invention in structural room: is under or in back of entertainment center (48) area where it meets with main cable to communicate to device such as a digital video recorder. Eighth suggested location placements of invention in structural room: is two more units of the invention at baseboard under beds area where it meets with main cable to communicate to device such as a digital video recorder. Ninth suggested location placements of invention in structural room: is four in each corner under box spring corners (13) at bed frame level area where it meets with main cable to communicate to device such as a digital video recorder.

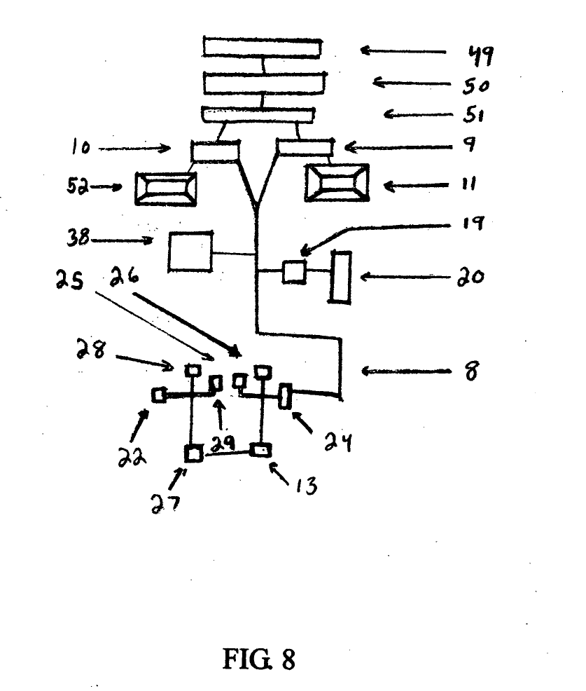

FIG. 8 is the 2D perspective view of a flow chart of the other common reactive electronic/non electronic, operating system devices when invention is in conjunction within order, to produce a immediate first alert digital notification to the pest management professional. The connections are compiled with each other operating type device's that unison the circuit of taxing a response warning, when a bed bug has entered and has triggered the invention. This sequence flow chart of events is starting from the received signal that the pest management professional has been notified. Trailing the path back to the original output digital triggered signals. The invention placements, and flow chart design, are geared for hotel/motel industry installation, but not limited too. Graphically illustrates the eight invention unit placements in hidden perspective view of a perspective locations (24, 26, 25, 13, 27, 29, 28, 22) in bed room, of any residential or commercial structure. This illustration is showing placements of invention, without plaster wall breach and without product conduits attachments on the exterior of wall voids. The illustration is showing the flow example of the connecting operating system devices that are also necessary to acquired separately to produce the signal from the invention. One of many possible alerts is from bed bug email alert (49) on a smart cell phone that a motion detection signal from one or more of the invention placements has had a triggered response, also, if programmed, the user(s) will be notified if the power went of line or one of the invention placements, or is being tampered with or removed without permission of the installer of the invention with out proper authorization to do so. This alert device requires a internet provider, (50) is necessary. The transfer of digital information to the user's smart phone (49) by airway control or land line depends on the internet provider also providing the pest management professional access to the users account to be able to retrieve there email account from a computer (10) or digital video recorder (9). The internet is connected to a router box, (51) with a digital address of the physical location of the structure, of where the signal is going and coming from the original transfer of information produced by other computerized operating device's that have translated information of a signal(s) originality being produced from one of the invention placements. The computerized systems such as digital video recorder (9) or computer lap top (10), interpret the electrical signals that are being produced from one of the (13) invention placements. These can be, but not limited to, digital video recorder with unlimited security camera channels. Amount of channels and invention placements that you decide depend on your investments with multi channel control DVR s. This illustration is showing only a eight channel capabilities (but not limited) to monitor the information signals that are produced by the ongoing monitoring invention placements that are positioned. The operations computerized system illustration, must have common programming that produce in that a motion detection sensitivity or threshold sensitivity on the matrix for every camera channel connection to work to produce a signal of the taxis response of bedbugs entering the interior of the invention placements (13). This is what produces a out going signal to produce a alarm, bells, lights or email notification on your smart cell phone. Visual monitoring (11, 52) any time to see inside invention placements are working properly is also achievable with a visual screen. This is also very important because you can not see with the naked eye if the infrared light emitting diodes are working without the camera on and functioning. If there is any burnout of light emitting diodes the invention will not show a picture on the (11) TV monitor. The invention needs power from a dispersing 12 vdc unit box (38) with circuit breaker and fuse control for each separate invention placement, that shuts off incase of short circuits with any of the invention placements, that outputs 12 volts direct current to the invention units. This power box for the invention placements runs at 800 mil-amps maximum before circuit breaker shuts off the invention, That is a separate fuse circuit breaker for each invention units, with 10 amps total for all of the power box. Included is a Co2 canister (20), with a regulator (19) that connects to a Co2 air tube (8) , that connects to all the invention placements. Each invention placement has a attached Co2 connector has a downgrade of orifice funnel FIG. 5 within and at near the entrance of the invention Co2 inlet tube. This insures quality control in slow release of the Co2 gas that's entering the inventions interior. The lines are inside a 50′ foot sheathed cable (8) that contains the power, the output for video NTSC and plastic tubing for Co2, connecting and combining all in one sheathed cable. Flow chart is only showing eight invention location placements FIG. 8 (but not limited to.) hooked up in a series connection informational circuit for demonstration purposes and small testing areas, But not limited to. First placement of invention behind right side view, where night stand (24) would be. Second placement of invention behind right side (top of invention connected facing wall) behind headboard (25) is placement of invention. Third placement of invention (26) under box spring at right front view connected at head corner of bed frame. Forth placement of invention (13) is under box spring connected to bed frame at right view foot corner. Fifth placement of invention (27) under box spring connected to left foot area of bed frame. Sixth placement of invention (28) under box spring connected to bed frame for left head corner of box spring frame. Seventh placement of invention (29) behind Left side (facing wall) behind headboard. Eighth placement of invention (22) behind night stand area for left side.

1. The invention bed bug insect peripheral electronic detection unit device (1) is an enclosure—rectangular box type chamber (1) with a crack and crevice entrance (2) at where a rectangular flat cap covers (3) a rectangular type box. (1) The warning device is comprised of compilations in the interior unit device, that includes a digital video camera component (4), a gel type trapping, non-trapping surface monitor (5), bed bug excrement scent lure (5), Co2 inlet connector tube (6) and warm heat from interior of unit infrared lights. (7) The insect bedbugs are the trigged indicators from their presence (7), after entering the interior of invention, of the bed bugs that were partially enticed. When the bed bug, but not limited to, has entered the interior of the invention (2), indication verification in conjunction with other common motion detection electronic devices FIG. 8, communicate with and in turns triggers other common computerized devices FIG. 8 which are connected to with wiring and tubes (8), but not limited to, intentionally alerting information to, such as a digital video recorder, (9) computer (10) with email alert, or visual identification on a TV Screen, (11) but not limited to. The invention is a device for extending and creating a first response alert, notifying the pest management professional where bed bugs are hiding near by (12) or on suspected locations of bed bugs in a structure and small structural insects, but not limited to. Some placement locations of the invention are as such as under the box springs (13) of beds, high-end at ceiling comers,(14) behind walls in outlet covers, behind or in dresser frames (15) and other locations where bed bugs are known to hide during the daytime for the best possible capture in the evening but not limited to.

2. A bed bug insect peripheral electronic detection unit device:
as claimed in claim 1 in which the invention comprises of;
1. Attractive gritty surface (16) fiat cap beveled edge rectangular shape. 3 Attached to the rectangular box with a spacer ring set (17) in parallel to create a crack and crevice for the invention.

3. A bed bug insect peripheral electronic detection unit device:
as in claim 1 wherein claims the invention may comprise of one or more of a attractant material lures to which the bed bugs may be enticed by their sensory and/or chemical affinity attractions to such as;
a) Bedbug excrement scent lure on a glue board surface trap (5) emitting from the interior of flap cap of the invention;
b) Where Co2 inlet lure (2) is also emitting from within invention;
c) also emitting (2) of slight warm heat produced from 4-6 infrared diode lights and camera enclosed in the back wall of the interior of the invention (7).

4. A bed bug insect peripheral electronic detection unit device:
as claimed in claim 1 and any of the preceding claims wherein the invention comprises a mini digital video camera (4) placed on the interior back wall within the invention. The bed bugs enter from a crack or crevice (2) of said invention on the opposite interior side of camera, by either being attracted to the lure(s) or just wandering in.

5. A bed bug insect peripheral electronic detection unit device:
as claimed in claim 1. Any of the preceding claims wherein or comprises of infrared diode(s) light (7) attached to the back wall of the interior of the invention in unison with the camera, (4) creating light for the interior of the unit box for the digital camera to focus and receive visual digital signals to export these signals (18) to other common digital devices producing a first alert.

6. A bed bug insect peripheral electronic detection unit device:
as claimed in claim 1. Any of the preceding claims in which; The exterior/interior encasement of invention (other than flat cap of invention) is a non gripping surface (1) and a non trapping surface of encasement invention is smooth that encloses and surrounds the interior and exterior.

7. A bed bug insect peripheral electronic detection unit device:
as claimed in claim 3b. Or any of the preceding claims in which;
Where Co2 inlet connector (6) lure is also emitting output from the interior of the invention from the (2) crack or crevice(s) between the connecting gritty surface flat cap and rectangular encasement of invention.

8. A bed bug insect peripheral electronic detection unit device:
as claimed in claim 3b any of the preceding claims wherein; a Co2 inlet tube connector entering from back wall area of chamber, next or near camera components of invention. Protruding Co2 inlet connector may be connected to a extension Co2 inlet tube, (8) which maybe of any length, which may be connected to a common Co2 output regulator, (19) that may be from any properly connected exterior (20) Co2 canister supply.
Placements

9. A bed bug insect peripheral electronic detection unit device:
as claimed in claim 1. The invention maybe attached by (21) clips, screws, Velcro or just sitting on to common surface's where bedbugs may enter the invention. This can be placements on floors, (15) in or attached to walls, on top, inside dressers, under, side attached to (13) bed frames, behind, under night stands (22) and including as hidden as (23) false wall receptacles.

10. A bed bug insect peripheral electronic detection unit device:
A device(s) substantially part of an operating system FIG. 8 as described herein with reference to a flow chart view of the reactive electronic operating system when circuits are completed with other operating device's taxing a response of a warning when a bed bug has entered any of the invention. As claimed and refereed to in claim 1.
